(19) United States
(12) Patent Application Publication
(10) Pub. No.: US 2022/0058774 A1
(43) Pub. Date: Feb. 24, 2022

(54) Systems and Methods for Performing Image Enhancement using Neural Networks Implemented by Channel-Constrained Hardware Accelerators

(71) Applicant: BlinkAI Technologies, Inc., Boston, MA (US)

(72) Inventors: Bo Zhu, Charlestown, MA (US); Haitao Yang, Boston, MA (US); Liying Shen, Charlestown, MA (US)

(73) Assignee: BlinkAI Technologies, Inc., Boston, MA (US)

(21) Appl. No.: 17/407,077

(22) Filed: Aug. 19, 2021

Related U.S. Application Data
(60) Provisional application No. 63/067,838, filed on Aug. 19, 2020.

(51) Int. Cl. G06T 5/00

(52) U.S. Cl. CPC G06T 5/001; G06T 2207/20084

(57) ABSTRACT

Systems and methods for performing image enhancement using neural networks implemented by channel-constrained hardware accelerators in accordance with embodiments of the invention are described. One embodiment includes providing at least a portion of an input image to an input layer of a neural network implemented by a hardware accelerator, where the neural network has a spatial resolution and a number of channels and the input layer has initial spatial dimensions and an initial number of channels, performing an initial transformation operation based upon an input signal to produce an intermediate signal having reduced spatial dimensions and an increased number of channels, where: the reduced spatial dimensions are reduced relative to the initial spatial dimensions, and the increased number of channels is greater than the initial number of channels, processing the intermediate signal using the hardware accelerator based upon the parameters of the neural network to produce an initial output signal, performing a reverse transformation based upon the initial output signal to produce an output signal having increased spatial dimensions and a reduced number of channels, where: the increased spatial dimensions are increased relative to the reduced spatial dimensions; and the reduced number of channels is less than the increased number of channels, providing the output signal to an output layer of the neural network to generate at least a portion of an enhanced image, and outputting a final enhanced image using at least the at least a portion of an enhanced image.

### CROSS-REFERENCE TO RELATED APPLICATIONS

The present application claims priority to U.S. Provisional Application Ser. No. 63/067,838, entitled “Systems and Methods for Performing Image Enhancement using Channel-Constrained Hardware Accelerators” to Zhu et al., filed Aug. 19, 2020, the disclosure of which is incorporated herein by reference in its entirety.

### FIELD OF THE INVENTION

The present invention relates generally to image processing and more specifically to the use of machine learning techniques to perform image enhancement using channel-constrained hardware accelerators.

### BACKGROUND

Images (e.g., digital images, video frames, etc.) may be captured by many different types of devices. For example, video recording devices, digital cameras, image sensors, medical imaging devices, electromagnetic field sensing, and/or acoustic monitoring devices may be used to capture images. Captured images may be of poor quality as a result of the environment or conditions in which the images were captured. For example, images captured in dark environments and/or under poor lighting conditions may be of poor quality, such that the majority of the image is largely dark and/or noisy. Captured images may also be of poor quality due to physical constraints of the device, such as devices that use low-cost and/or low-quality imaging sensors.

### BRIEF DESCRIPTION OF THE DRAWINGS

FIG. 1 conceptually illustrates a distributed computing system that may be utilized for image enhancement using neural networks in accordance with several embodiments of the invention.

FIG. 2 conceptually illustrates an image enhancement system that may be utilized for image enhancement using neural networks in accordance with several embodiments of the invention.

FIG. 3 conceptually illustrates space-to-depth and depth-to-space operations in accordance with several embodiments of the invention.

FIG. 4 conceptually illustrates space-to-depth operations performed in the context of optical flow of mosaiced images in accordance with several embodiments of the invention.

FIG. 5 conceptually illustrates the construction of a neural network corresponding to a neural network having higher spatial resolution convolutional layers through the use of space-to-depth transformations to encode spatial information at a reduced spatial resolution by encoding some of the spatial information within additional channels in accordance with an embodiment of the invention.

FIG. 6 conceptually illustrates the manner in which the performance of an input, output, and/or convolutional layer feature map having a specific spatial resolution that is greater than the spatial resolution that can be implemented on a particular hardware accelerator, but a channel count that is less than the number of channels that can be supported by the hardware accelerator, can be equivalently implemented using a corresponding lower spatial resolution input, output, and/or convolutional layer feature map by utilizing an increased number of channels in accordance with an embodiment of the invention.

FIG. 7 illustrates a process for enhancing images using neural networks implemented by channel-constrained hardware accelerators in accordance with an embodiment of the invention.

### DETAILED DESCRIPTION

Systems and methods for performing image enhancement using neural networks implemented by channel-constrained hardware accelerators in accordance with various embodiments of the invention are illustrated. In a number of embodiments, image enhancement is performed using channel-constrained hardware accelerators. In several embodiments, a neural network (NN) is utilized to perform image enhancement that takes an input image and performs a space-to-depth (s2) operation to output data having spatial dimensions and a number of channel appropriate to the spatial dimensions and number of channels supported by a particular hardware accelerator. In this way, the NN can process images and/or image patches more efficiently by exploiting image input or image feature map data having a number of channels that is less than the lowest multiple of the optimal number of channels that is efficiently supported by the hardware accelerator. By shifting information from spatial inputs of a feature map into additional available channels in a defined way, neural networks can be implemented more efficiently.

A neural network in accordance with a number of embodiments of the invention can enable recovery of an enhanced image at a desired spatial resolution by performing an inverse depth-to-space (d2s) transformation prior to outputting the enhanced image. In a number of embodiments, an input image (or sequence of input images) is divided up into image patches that are provided to the NN for image enhancement. A number of pixels that is greater than the spatial dimensions (receptive field) of the NN can be processed by using an s2d operation to transfer spatial information into additional available channels. Enhanced image patches can be recovered using a d2s operation. In the absence of the transformations, a larger input image or patch would need to be processed and each image or patch would be processed by the hardware accelerator in a manner that does not utilize all available channels. Systems and methods that employ NNs employing s2d and d2s operations to perform image enhancement on input images in accordance with various embodiments of the invention are discussed further below.

Systems for Performing Image Enhancement using Neural Networks

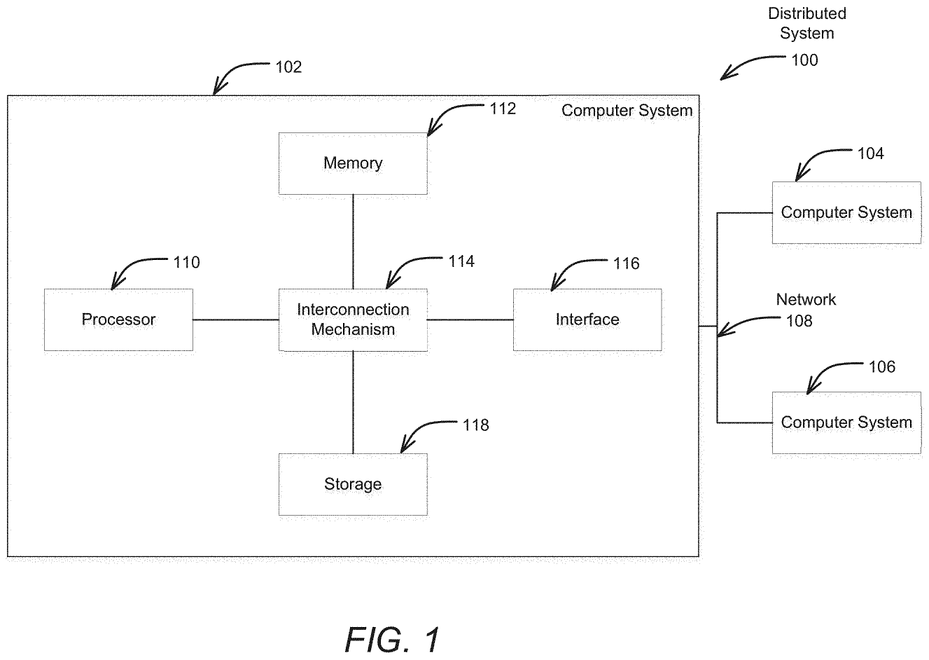

FIG. 1 shows a block diagram of a specially configured distributed computer system 100, in which various aspects may be implemented. As shown, the distributed computer system 100 includes one or more computer systems that exchange information. More specifically, the distributed computer system 100 includes computer systems 102, 104, and 106. As shown, the computer systems 102, 104, and 106 are interconnected by, and may exchange data through, a communication network 108. The network 108 may include any communication network through which computer systems may exchange data. To exchange data using the network 108, the computer systems 102, 104, and 106 and the network 108 may use various methods, protocols and standards, including, among others, Fiber Channel, Token Ring, Ethernet, Wireless Ethernet, Bluetooth, IP, IPV6, TCP/IP, UDP, DTN, HTTP, FTP, SNMP, SMS, MIMS, SS6, JSON, SOAP, CORBA, REST, and Web Services. To ensure data transfer is secure, the computer systems 102, 104, and 106 may transmit data via the network 108 using a variety of security measures including, for example, SSL or VPN technologies. While the distributed computer system 100 illustrates three networked computer systems, the distributed computer system 100 is not so limited and may include any number of computer systems and computing devices, networked using any medium and communication protocol.

As illustrated in FIG. 1, the computer system 102 includes a processor 110, a memory 112, an interconnection element 114, an interface 116 and data storage element 118. To implement at least some of the aspects, functions, and processes disclosed herein, the processor 110 can perform a series of instructions that result in manipulated data. The processor 110 may be any type of processor, multiprocessor or controller. Example processors may include a commercially available processor such as an Intel Xeon, Itanium, Core, Celeron, or Pentium processor; an AMD Opteron processor; an Apple A10 or A5 processor; a Sun UltraSPARC processor; an IBM Power5+ processor; an IBM mainframe chip; or a quantum computer. The processor 110 is connected to other system components, including one or more memory devices 112, by the interconnection element 114.

The memory 112 stores programs (e.g., sequences of instructions coded to be executable by the processor 110) and data during operation of the computer system 102. Thus, the memory 112 may be a relatively high performance, volatile, random access memory such as a dynamic random access memory (“DRAM”) or static memory (“SRAM”). However, the memory 112 may include any device for storing data, such as a disk drive or other nonvolatile storage device. Various examples may organize the memory 112 into particularized and, in some cases, unique structures to perform the functions disclosed herein. These data structures may be sized and organized to store values for particular data and types of data.

Components of the computer system 102 are coupled by an interconnection element such as the interconnection mechanism 114. The interconnection element 114 may include any communication coupling between system components such as one or more physical busses in conformance with specialized or standard computing bus technologies such as IDE, SCSI, PCI and InfiniBand. The interconnection element 114 enables communications, including instructions and data, to be exchanged between system components of the computer system 102.

The computer system 102 also includes one or more interface devices 116 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 102 to exchange information and to communicate with external entities, such as users and other systems.

The data storage element 118 includes a computer readable and writeable nonvolatile, or non-transitory, data storage medium in which instructions are stored that define a program or other object that is executed by the processor 110. The data storage element 118 also may include information that is recorded, on or in, the medium, and that is processed by the processor 110 during execution of the program. More specifically, the information may be stored in one or more data structures specifically configured to conserve storage space or increase data exchange performance. The instructions may be persistently stored as encoded signals, and the instructions may cause the processor 110 to perform any of the functions described herein. The medium may, for example, be optical disk, magnetic disk or flash memory, among others. In operation, the processor 110 or some other controller causes data to be read from the nonvolatile recording medium into another memory, such as the memory 112, that allows for faster access to the information by the processor 110 than does the storage medium included in the data storage element 118. The memory may be located in the data storage element 118 or in the memory 112, however, the processor 110 manipulates the data within the memory, and then copies the data to the storage medium associated with the data storage element 118 after processing is completed. A variety of components may manage data movement between the storage medium and other memory elements and examples are not limited to particular data management components. Further, examples are not limited to a particular memory system or data storage system.

Although the computer system 102 is shown by way of example as one type of computer system upon which various aspects and functions may be practiced, aspects and functions are not limited to being implemented on the computer system 102 as shown in FIG. 1. Various aspects and functions may be practiced on one or more computers having a different architectures or components than that shown in FIG. 1. For instance, the computer system 102 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 102 may be a computer system including an operating system that manages at least a portion of the hardware elements included in the computer system 102. In some examples, a processor or controller, such as the processor 110, executes an operating system. Examples of a particular operating system that may be executed include a Windows-based operating system, such as, Windows NT, Windows 2000 (Windows ME), Windows XP, Windows Vista or Windows 6, 8, or 6 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Oracle Corporation, or a UNIX operating systems available from various sources. Many other operating systems may be used, and examples are not limited to any particular operating system.

The processor 110 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

Based on the foregoing disclosure, it should be apparent to one of ordinary skill in the art that the embodiments disclosed herein are not limited to a particular computer system platform, processor, operating system, network, or communication protocol. Also, it should be apparent that the embodiments disclosed herein are not limited to a specific architecture.

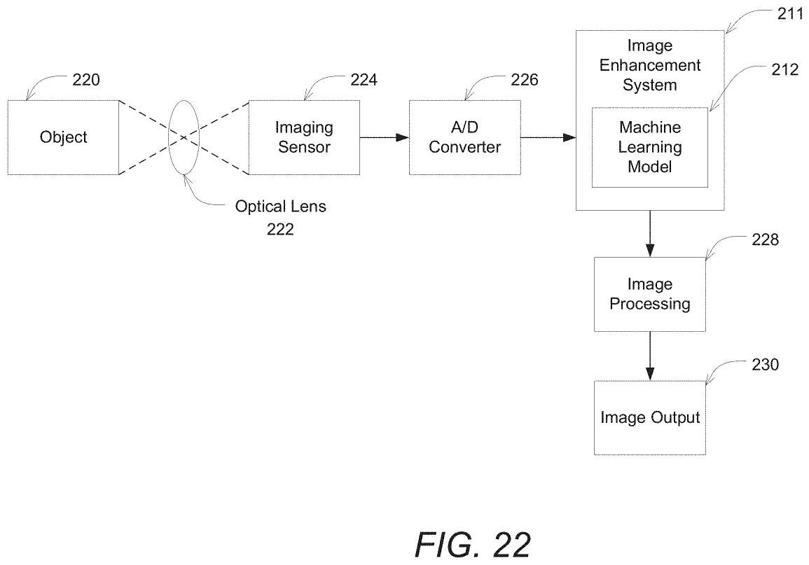

FIG. 2 illustrates an example implementation of an image enhancement system 211 for performing image enhancement of an image captured by an imaging device in accordance with several embodiments of the invention. Light waves from an object 220 pass through an optical lens 222 of the imaging device and reach an imaging sensor 224. The imaging sensor 224 receives light waves from the optical lens 222, and generates corresponding electrical signals based on intensity of the received light waves. The electrical signals are then transmitted to an analog to digital (ND) converter which generates digital values (e.g., numerical RGB pixel values) of an image of the object 220 based on the electrical signals. The image enhancement system 211 receives the image and uses the trained machine learning system 212 to enhance the image. For example, if the image of the object 220 was captured in low light conditions in which objects are blurred and/or there is poor contrast, the image enhancement system 211 may de-blur the objects and/or improve contrast. The image enhancement system 211 may further improve brightness of the images while making the objects more clearly discernible to the human eye. The image enhancement system 211 may output the enhanced image for further image processing 228. For example, the imaging device may perform further processing on the image (e.g., brightness, white, sharpness, contrast). The image may then be output 230. For example, the image may be output to a display of the imaging device (e.g., display of a mobile device), and/or be stored by the imaging device.

In some embodiments, the image enhancement system 211 may be optimized for operation with a specific type of imaging sensor 224. By performing image enhancement on raw values received from the imaging sensor before further image processing 228 performed by the imaging device, the image enhancement system 211 may be optimized for the imaging sensor 224 of the device. For example, the imaging sensor 224 may be a complementary metal-oxide semiconductor (CMOS) silicon sensor that captures light. The sensor 224 may have multiple pixels which convert incident light photons into electrons, which in turn generates an electrical signal is fed into the A/D converter 226. In another example, the imaging sensor 224 may be a charge-coupled device (CCD) sensor. Some embodiments are not limited to any particular type of sensor.

In some embodiments, the image enhancement system 211 may be trained based on training images captured using a particular type or model of an imaging sensor. Image processing 228 performed by an imaging device may differ between users based on particular configurations and/or settings of the device. For example, different users may have the imaging device settings set differently based on preference and use. The image enhancement system 211 may perform enhancement on raw values received from the A/D converter to eliminate variations resulting from image processing 220 performed by the imaging device.

In some embodiments, the image enhancement system 211 may be configured to convert a format of numerical pixel values received from the ND converter 226. For example, the values may be integer values, and the image enhancement system 211 may be configured to convert the pixel values into float values. In some embodiments, the image enhancement system 211 may be configured to subtract a black level from each pixel. The black level may be values of pixels of an image captured by the imaging device with show no color. Accordingly, the image enhancement system 211 may be configured to subtract a threshold value from pixels of the received image. In some embodiments, the image enhancement system 211 may be configured to subtract a constant value from each pixel to reduce sensor noise in the image. For example, the image enhancement system 111 may subtract 60, 61, 62, or 63 from each pixel of the image.

In some embodiments, the image enhancement system 211 may be configured to normalize pixel values. In some embodiments, the image enhancement system 111 may be configured to divide the pixel values by a value to normalize the pixel values. In some embodiments, the image enhancement system 211 may be configured to divide each pixel value by a difference between the maximum possible pixel value and the pixel value corresponding to a black level (e.g., 60, 61, 62, 63). In some embodiments, the image enhancement system 211 may be configured to divide each pixel value by a maximum pixel value in the captured image, and a minimum pixel value in the captured image.

In some embodiments, the image enhancement system 211 may be configured to perform demosaicing to the received image. The image enhancement system 211 may perform demosaicing to construct a color image based on the pixel values received from the ND converter 226. The system 211 may be configured to generate values of multiple channels for each pixel. In some embodiments, the system 211 may be configured to generate values of four color channels. For example, the system 211 may generate values for a red channel, two green channels, and a blue channel (RGGB). In some embodiments, the system 211 may be configured to generate values of three color channels for each pixel. For example, the system 211 may generate values for a red channel, green channel, and blue channel.

In some embodiments, the image enhancement system 211 may be configured to divide up the image into multiple portions. The image enhancement system 211 may be configured to enhance each portion separately, and then combine enhanced versions of each portion into an output enhanced image. The image enhancement system 211 may generate an input to the machine learning system 212 for each of the received inputs. For example, the image may have a size of 500×500 pixels and the system 211 may divide the image into 100×100 pixel portions. The system 211 may then input each 100×100 portion into the machine learning system 212 and obtain a corresponding output. The system 211 may then combine the output corresponding to each 100×100 portion to generate a final image output. In some embodiments, the system 211 may be configured to generate an output image that is the same size as the input image.

Although specific architectures are discussed above with respect to FIGS. 1 and 2, one skilled in the art will recognize that any of a variety of computing architectures may be utilized in accordance with embodiments of the invention.

Performing Image Enhancement using S2D and D2S Operations in a NN

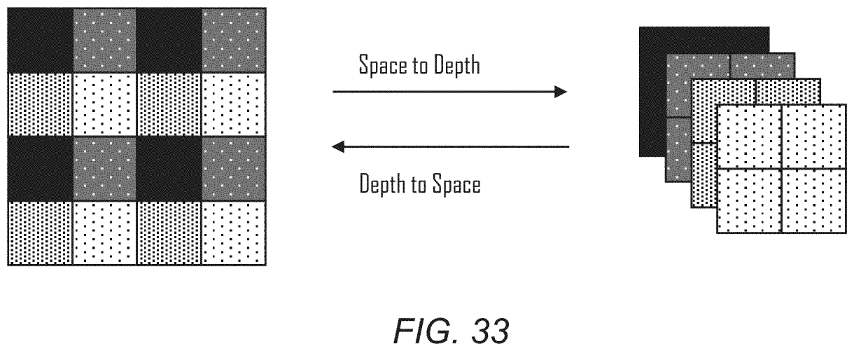

Neural networks that can be utilized to perform image enhancement are described in U.S. Patent Pub. No. 2020/0051217, the complete disclosure of which including the disclosure related to systems and methods that utilize neural networks to perform image enhancement and the specific disclosure relevant to FIGS. 3B, 3C, 8 and 9 found in paragraphs including (but not limited to) paragraphs [0055]-[0077], [0083]-[0094], [0102]-[0110], [0124]-[0126], [0131], [0135]-[0148], [0178]-[0200] and is hereby incorporated by reference in its entirety.

NN hardware acceleration platforms (and the software frameworks that run on them) are often optimized to compute and perform memory I/O on weights and feature maps with channel counts being a multiple of a number (e.g. 32) due to data structure alignment design within the accelerator hardware. This means a lightweight NN using fewer channels (e.g. fewer than 32) may not take full advantage of the computational resources (and therefore not gain additional inference speed).

In a number of embodiments, an arbitrary image-input is transformed using an s2d operation to transform data expressed in input spatial dimensions and channels into spatial dimensions and a number of channels that increases the computational efficiency that can be achieved through the use of particular hardware accelerator when performing image enhancement. An s2d operation in accordance with some embodiments of the invention is conceptually illustrated in FIG. 3 and moves activations from the spatial dimension to the channel dimension. In the illustrated embodiment, one channel of the image or feature map is transformed by the s2d operation in a 2×2 block pattern into four channels with half original height and width. If the input contains more than one channel, each channel can be converted in the manner described, and the transformed results are concatenated in the channel dimension. The corresponding depth-to-space (d2s) operation is the inverse.

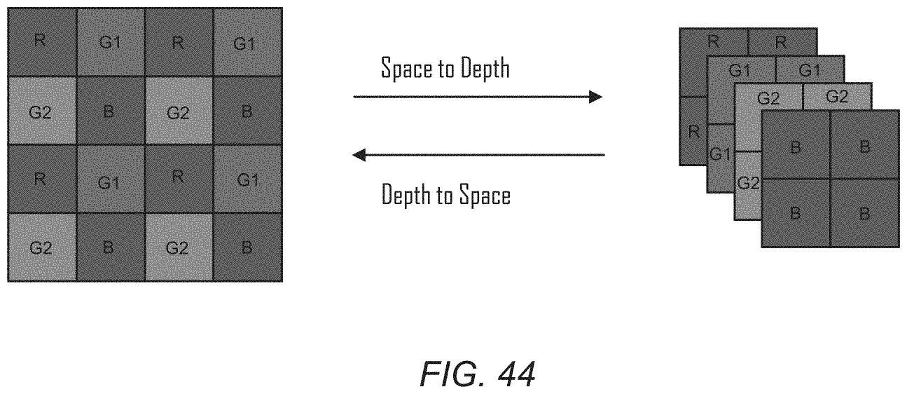

Application of a s2d operation in the context of image sensor raw Bayer data in a typical RGGB configuration in accordance with some embodiments of the invention is conceptually illustrated in FIG. 4. Red pixels are denoted with R, blue pixels with B, and two sets of green pixels with G1 and G2. The corresponding color pixels can be shifted to an intermediate signal of 2×2 blocks for four channels, one channel each containing a block of red pixels, a block of blue pixels, and two blocks of green pixels.

Transforming an input by a s2d operation can map pixels or other expressions of data from an input image into locations of an intermediate signal by any of a variety of schemes in accordance with embodiments of the invention, and the corresponding d2s operation includes the inverse mapping. For example, the mapping can take every Nth pixel (where N is the factor by which the number of channels is increased), starting from a first pixel, and map it to a predetermined location in a channel in the intermediate signal. The next set of Nth pixels, starting from the second pixel, can be mapped into a predetermined location in a next channel in the intermediate signal and so on. When N is 4, the first pixel, the fifth pixel, the ninth pixel, etc. will be mapped to locations in a first channel in the intermediate signal. The second pixel, the sixth pixel, the tenth pixel, etc. will be mapped to locations in a second channel in the intermediate signal. The corresponding d2s operation will be the inverse and map the pixels or data back to the original locations in an output image.

While the examples above divide height by two and width by two, and then correspondingly increase number of channels by four, one skilled in the art will recognize that any of a variety of factors may be utilized to reduce the dimensions of an initial input into an intermediate signal and increase the number of channels. For example, height and width of a 9×9 input in one channel can each be divided by three (H/3 and W/3) to create an intermediate signal of 3×3 blocks in nine channels. Additional embodiments of the invention contemplate input signals having other dimensions and/or more than one channel.

The s2d operation may be used multiple times within a NN implemented in accordance with an embodiment of the invention, for example, converting an input or feature map from H,W,C to H/2,W/2, C*4 and then to H/4,W/4, C*16, where H is height, W is width, and C is number of channels. As can readily be appreciated, any of a number of s2d operations can be performed including an initial transformation to extract channels of information from raw image data followed by one or more subsequent s2d operations to transform spatial information into additional channels to gain increased efficiency during NN processing performed by a processing system using a hardware accelerator.

Typically, the purpose in utilizing s2d is to perform lossless downsampling to reduce the spatial extent of NN layers without losing spatial information. In a number of embodiments of the invention, however, the use of the s2d operation serves to increase the depth/channel processing performed by the NN hardware acceleration to fully utilize the channel counts optimally supported by the hardware acceleration platform without incurring computational latency due to channel-wise parallel processing. In many embodiments, the s2d operation also provides the additional benefit of spatial extent reduction which further improves inference computation speed as the convolutional kernels are required to raster over fewer spatial pixels, ultimately enabling processing of more images for a given time duration (e.g. frames per second in a video sequence) or larger numbers of pixels for each image.

Systems for Image Enhancement using S2D and D2S Operations in a NN

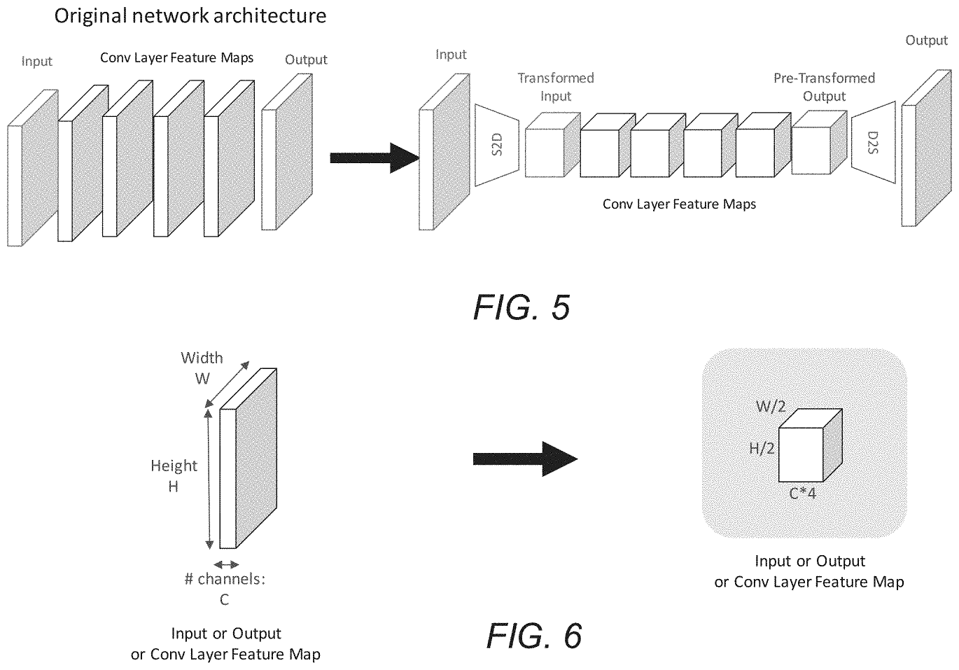

A comparison between a NN utilized to perform image enhancement at a channel count determined by an input image and in a NN where a s2d operation is used to fully utilize the channel count of a hardware accelerator during the image enhancement process in accordance with several embodiments of the invention is conceptually illustrated in FIGS. 5 and 6. FIG. 5 illustrates on the left-side the processing path with the original dimensions of an input, four convolutional layer feature maps of a neural network processing the input, and the matching dimensions of an output. On the right-side is illustrated the processing path of an input passed to an s2d operation that produces a transformed input having different dimensions and number of channels, four convolutional layer feature maps of a neural network processing the input, a pre-transformed output that matches the dimensions and number of channels of the transformed input, and an output converted by a d2s operation from the pre-transformed output that matches the dimensions and number of channels of the original input.

FIG. 6 illustrates how the dimensions of an input, output, and/or convolutional layer feature map may be related to a transformed input provided to a neural network, a pre-transformed output of the neural network, and/or a convolutional layer feature map in accordance with some embodiments of the invention. On the left are dimensions of the input, output, or feature map having height H, width W, and number of channels C. On the right are dimensions of the transformed input, pre-transformed output, or feature map having reduced height H/2, reduced width W/2, and increased number channels C*4.

While specific NN architectures are shown in FIGS. 5 and 6 and are described above (including in U.S. Patent Publication No. 2020/0051217), any of a variety of techniques and/or operations that can be utilized to map spatial information and/or pixels from multiple frames of video into additional channels to increase the number of channels processed during NN computations can be utilized as appropriate to the requirements of specific applications in accordance with various embodiments of the invention.

Processes for Image Enhancement using S2D and D2S Operations in a NN

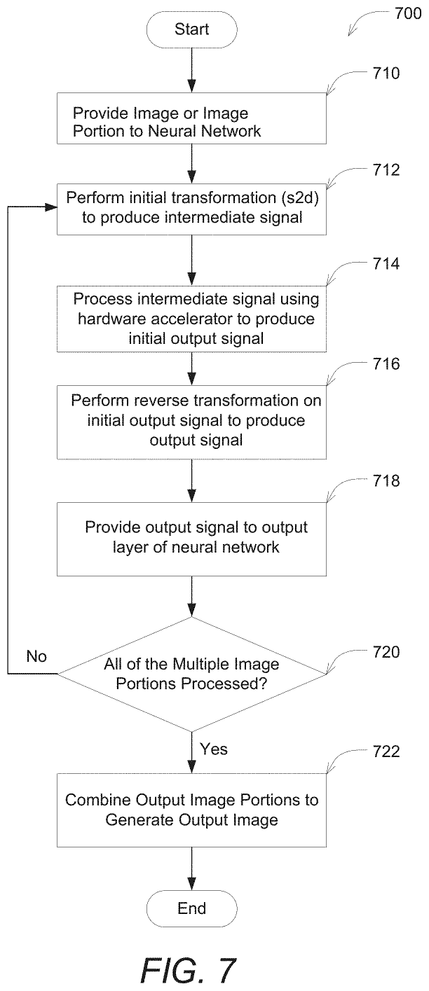

Processes may be implemented on computing platforms such as those discussed further above with respect to FIGS. 1 and 2 to perform image enhancement using s2d and d2s operations in accordance with embodiments of the invention. For example, memory on a computing device can include an image enhancement application and parameters of a neural network. A processor or processing system on the computing device can include a hardware accelerator capable of implementing the neural network with a spatial resolution (e.g., height and width) and number of channels. The processor or processing system can be configured by the image enhancement application to implement the neural network and perform processes for image enhancement. A process in accordance with embodiments of the invention is illustrated in FIG. 7. The process 700 includes receiving an image and providing (710) at least a portion of the input image to an input layer of the neural network, where the input layer has initial spatial dimensions and an initial number of channels.

An initial transformation is performed (712) based on an input signal to produce an intermediate signal having reduced spatial dimensions (reduced relative to the initial spatial dimensions) and an increased number of channels (increased relative to the initial number of channels). In several embodiments of the invention, the initial transformation can be a space-to-depth (s2d) operation such as described further above. In some embodiments the input signal is the at least a portion of the input image. In other embodiments, the input signal can be an activation map or a feature map. The intermediate signal input image, activation map, or feature map.

The intermediate signal is processed (714) using the hardware accelerator based upon the parameters of the neural network to produce an initial output signal. As discussed above, the convolutional layers of the neural network can have spatial resolution or dimensions that match the those of the intermediate signal. In many embodiments of the invention, the hardware accelerator has a number of channels that can be simultaneously processed and the increased number of channels equals the maximum number of channels of the hardware accelerator. The number of channels of the hardware acceleration can match the number of channels of the intermediate signal.

A reverse transformation is performed (716) on the initial output signal to produce an output signal having increased spatial dimensions (increased relative to the reduced spatial dimensions) and a reduced number of channels (reduced relative to the reduced number of channels), where the reverse transformation is the inverse of the initial transformation. In many embodiments of the invention the increased spatial dimensions are the same as the initial spatial dimensions and the reduced number of channels is the same as the initial number of channels. In several embodiments of the invention, the initial transformation can be a depth-to-space (d2s) operation such as described further above.

The output signal is provided (718) to the output layer of the neural network to generate at least a portion of an enhanced image. If there are additional image portions to process, the process can repeat from performing (712) initial transformation on the additional portions. Then the output image portions can be combined (722) to a final output image. In additional embodiments of the invention, the input image is part of a sequence of input images and the process can provide each of the input images in the sequence or portions of the images to be processed as described above.

Although a specific process is described above with respect to FIG. 7, one skilled in the art will recognize than any of a variety of processes may be utilized for image enhancement using neural networks implemented by channel-constrained hardware accelerators in accordance with embodiments of the invention.

While much of the discussion that follows is presented in the context of systems and methods that utilize channel-constrained hardware accelerators, image enhancement systems and methods can be implemented using any of a variety of hardware and/or processing architectures as appropriate to the requirements of specific applications in accordance with various embodiments of the invention. Accordingly, the systems and methods described herein should be understood as being in no way limited to requiring the use of a hardware accelerator and/or a hardware accelerator having specific characteristics. Furthermore, the operations utilized to map spatial information from a single frame and/or multiple frames into additional available channels that can be processed by a processing system are not limited to s2d operations. Indeed, any appropriate transformation can be utilized in accordance with the requirements of specific applications in accordance with various embodiments of the invention. More generally, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

What is claimed is:

1. A system for automatically enhancing a digital image, the system comprising:
a memory containing an image enhancement application and parameters of a neural network; and
a processing system comprising a hardware accelerator, where the hardware accelerator is capable of implementing a neural network having a spatial resolution and a number of channels;
wherein the image enhancement application configures the processing system to:
provide at least a portion of an input image to an input layer of the neural network, where the input layer has initial spatial dimensions and an initial number of channels;
perform an initial transformation operation based upon an input signal to produce an intermediate signal having reduced spatial dimensions and an increased number of channels, where:
the reduced spatial dimensions are reduced relative to the initial spatial dimensions; and
the increased number of channels is greater than the initial number of channels;
process the intermediate signal using the hardware accelerator based upon the parameters of the neural network to produce an initial output signal;
perform a reverse transformation based upon the initial output signal to produce an output signal having increased spatial dimensions and a reduced number of channels, where:
the increased spatial dimensions are increased relative to the reduced spatial dimensions; and
the reduced number of channels is less than the increased number of channels;
provide the output signal to an output layer of the neural network to generate at least a portion of an enhanced image; and
output a final enhanced image using at least the at least a portion of an enhanced image.

2. The system of claim 1, wherein the input signal comprises at least a portion of the input image.

3. The system of claim 1, wherein the input signal comprises an activation map.

4. The system of claim 1, where the input signal comprises a feature map.

5. The system of claim 1, wherein the increased spatial dimensions are the same as the initial spatial dimensions and the reduced number of channels is the same as the initial number of channels.

6. The system of claim 1, wherein:
the initial transformation is a space-to-depth operation; and
the reverse transformation is a depth-to-space operation.

7. The system of claim 1, wherein the hardware accelerator has a number of channels that can be simultaneously processed and the increased number of channels equals the maximum number of channels of the hardware accelerator.

8. The system of claim 1, wherein:
the processing system further comprises an application processor; and
the image enhancement application configures the application processor to:
provide the at least a portion of the input image from the sequence of input images to an input layer of the neural network;
perform the initial transformation operation;
perform the reverse transformation;
provide the output signal to an output layer; and
output the final enhanced image.

9. The system of claim 1, wherein provide at least a portion of an input image to an input layer of the neural network further comprises provide at least portions of a plurality of images from a sequence of input images including the input image to the input layer of the neural network.

10. A method for automatically enhancing a digital image, the method comprising:
providing at least a portion of an input image to an input layer of a neural network implemented by a hardware accelerator, where the neural network has a spatial resolution and a number of channels and the input layer has initial spatial dimensions and an initial number of channels;
performing an initial transformation operation based upon an input signal to produce an intermediate signal having reduced spatial dimensions and an increased number of channels, where:
the reduced spatial dimensions are reduced relative to the initial spatial dimensions; and
the increased number of channels is greater than the initial number of channels;
processing the intermediate signal using the hardware accelerator based upon the parameters of the neural network to produce an initial output signal;
performing a reverse transformation based upon the initial output signal to produce an output signal having increased spatial dimensions and a reduced number of channels, where:
the increased spatial dimensions are increased relative to the reduced spatial dimensions; and
the reduced number of channels is less than the increased number of channels;
providing the output signal to an output layer of the neural network to generate at least a portion of an enhanced image; and
outputting a final enhanced image using at least the at least a portion of an enhanced image.

11. The system of claim 1, where the input signal comprises at least a portion of the input image.

12. The system of claim 1, where the input signal comprises an activation map.

13. The system of claim 1, where the input signal comprises a feature map.

14. The system of claim 1, wherein the increased spatial dimensions are the same as the initial spatial dimensions and the reduced number of channels is the same as the initial number of channels.

15. The system of claim 1, wherein:
the initial transformation is a space-to-depth operation; and
the reverse transformation is a depth-to-space operation.

16. The system of claim 1, wherein the hardware accelerator has a number of channels that can be simultaneously processed and the increased number of channels equals the maximum number of channels of the hardware accelerator.

17. The system of claim 1, wherein:
the processing system further comprises an application processor; and
the image enhancement application configures the application processor to:
provide the at least a portion of the input image from the sequence of input images to an input layer of the neural network;
perform the initial transformation operation;
perform the reverse transformation;
provide the output signal to an output layer; and
output the final enhanced image.

18. The system of claim 1, wherein provide at least a portion of an input image to an input layer of the neural network further comprises provide at least portions of a plurality of images from a sequence of input images including the input image to the input layer of the neural network.
